(19) United States
(12) Patent Application Publication
(10) Pub. No.: US 2007/0156807 A1
(43) Pub. Date: Jul. 5, 2007

(54) Data transmission method and arrangement for data transmission

(76) Inventors: Jian Ma, Beijing (CN); Hannu Flinck, Helsinki (FI)

Correspondence Address: Hollingsworth & Funk, LLC, Suite 125, 8009 34th Avenue South, Minneapolis, MN, 55425, US

(21) Appl. No.: 11/321,472

(22) Filed: Dec. 29, 2005

(51) Int. Cl. G06F 15/16

(52) U.S. Cl. 709/203

(57) ABSTRACT

An arrangement and a data transmission method are disclosed. The amount of traffic originated by the subscriptions of syndicated web feeds by terminals using point-to-point connections is monitored, the terminals being capable of broadcast reception. The cost of delivering the amount of traffic is compared to a threshold value. If the cost exceeds the threshold value the web feed is redirected to a broadcast network which starts transmitting the feed. A message is sent to the terminals capable of broadcast reception and subscribing to the feed, the message indicating a command to start receiving the feed from the broadcast network.

### FIELD

The invention relates to data transmission. In particular, the invention relates to distributing data from the Internet to a number of terminals using broadcasting.

### BACKGROUND

A modern way of publishing information in the Internet is web syndication. In web syndication, contents of an Internet site are made publicly available by using web feeds. A web feed is a format of information, typically but not necessarily an XML-based document containing structured content. Web feeds may contain summaries of larger information items and links to these items. The items may be text, images, audio clips, video clips, or any other information presented in a web site. Several web feed formats are currently in use, such as RSS 0.91 (Rich Site Summary), RSS 1.0 (RDF Site Summary, RSS 2.0 (Really Simple Syndication) and ATOM.

Web feeds are typically read by a feed reader program or an aggregator. The user may subscribe to a web feed by including the address of the feed in a subscription list of the feed reader program. The feed reader can automatically check the subscribed web feeds and display any updated information found. Web feeds and the feed reader programs present the user a convenient way of monitoring the content of interesting Internet sites.

The usage of Internet has been growing continuously for several years and will likely continue to grow. The number of web sites is continuously increasing. However, it has been estimated that a small percentage of all Internet sites experience the most visits and contain the most popular and requested content. Thus, these sites generate a majority of Internet traffic.

It has been estimated that the most popular Internet sites have less than 30 GB of information updated daily. Although 30 GB data per a day is not such a significant amount of data, it still consumes a huge Internet bandwidth because the same content is accessed by many users and thus the total traffic amount multiplied: For example, if each user consumes a certain bandwidth, such as 1 MB, the same data downloaded by 1000 users in a day will consume 1 GB of bandwidth. In principle, broadcasting the same data over the air would be the most efficient way to distribute this content in terms of bandwidth to a large number of users. However, broadcasting all information downloaded from the Internet would not be practical.

### BRIEF DESCRIPTION OF THE INVENTION

An object of the invention is to provide a solution for distributing data from the Internet to a number of terminals using broadcasting. According to an aspect of the invention, there is provided a data transmission method, the method comprising monitoring the amount of traffic originated by the subscriptions of syndicated web feeds by terminals using point-to-point connections, the terminals being capable of broadcast reception; comparing the cost of delivering the amount of traffic to a predetermined threshold value; and if the cost of delivering the amount of traffic of a given web feed exceeds the threshold value; aggregating the web feed and redirecting the feed to a broadcast network; sending a message to the terminals capable of broadcast reception and subscribing to the feed, the message indicating a command to start receiving the feed from the broadcast network; transmitting the feed from the broadcast network.

According to another aspect of the invention, there is provided a data transmission method, the method comprising monitoring the amount of traffic originated by the subscriptions of syndicated web feeds by terminals using point-to-point connections, the terminals being capable of broadcast reception; comparing the amount of traffic to a predetermined threshold value; and if the amount of traffic of a given web feed exceeds the threshold value; aggregating the web feed and redirecting the feed to a broadcast network; sending a message to the terminals capable of broadcast reception and subscribing to the feed, the message indicating a command to start receiving the feed from the broadcast network; transmitting the feed from the broadcast network.

According to another aspect of the invention, there is provided an arrangement for data transmission, comprising a server configured to monitor the amount of traffic originated by the subscriptions of syndicated web feeds by terminals using point-to-point connections, the terminals being capable of broadcast reception; compare the cost of delivering the amount of traffic to a predetermined threshold value; and if the cost of delivering the amount of traffic of a given web feed exceeds the threshold value, the server is configured to aggregate the web feed and redirect the feed to a broadcast network; send a message to the terminals capable of broadcast reception and subscribing to the feed, the message indicating a command to start receiving the feed from the broadcast network.

According to another aspect of the invention, there is provided a terminal comprising a first transceiver having a point-to-point connection with the Internet and receiving syndicated web feeds using a point-to-point connection; a receiver receiving broadcast transmissions, a second transceiver receiving a message on a point-to-point connection, the message identifying a syndicated feed received using a point-to-point connection, broadcast transmission parameters and information that the feed may be decoded from a broadcast transmission using the broadcast transmission parameters, and a controller initiating broadcast reception on the basis of the received message.

According to yet another aspect of the invention, there is provided a computer program distribution medium readable by a computer and encoding a computer program of instructions for executing a computer process for data transmission, the process comprising: monitoring the amount of traffic originated by the subscriptions of syndicated web feeds by terminals using point-to-point connections, the terminals being capable of broadcast reception; comparing the cost of delivering the amount of traffic to a predetermined threshold value; and if the cost of delivering the amount of traffic of a given web feed exceeds the threshold value, aggregating the web feed and redirecting the feed to a broadcast network; and sending a message to the terminals capable of broadcast reception and subscribing to the feed, the message indicating a command to start receiving the feed from the broadcast network.

The invention provides several advantages. The total amount of traffic related to Internet browsing is reduced drastically by using a broadcast network for the transmission of popular content. By using a broadcast network individual downloads from separate users are eliminated. By monitoring traffic of web feeds it is possible to determine which web feeds are most popular and generate a significant amount of traffic. In an embodiment of the invention, the measured amount of traffic of a feed is used to determine whether it would be efficient to transmit the feed using a broadcast network to the subscribers instead of letting the subscribers load the feed independently. In an embodiment of the invention, the cost of the delivery of the amount of traffic is used to determine whether it would be efficient to transmit the feed using a broadcast network. The cost of delivery may comprise cost of transport, and the load to servers and the network, for example. This optimizes the use of network resources, particularly the air resources, as well as the power consumption of the terminals as broadcast receiving requires less power than maintaining for example a cellular data/GRPS connections only for checking preferred RSS feeds. Naturally, the presented solution is suitable for only those users who have terminal equipment capable of receiving transmissions from broadcast networks.

### LIST OF DRAWINGS

In the following, the invention will be described in greater detail with reference to the embodiments and the accompanying drawings, in which

FIG. 1A illustrates an example of a system,

FIG. 1B illustrates an example of broadcast transmission,

FIG. 2 illustrates an example of a terminal,

FIGS. 3A and 3B are flowcharts illustrating an embodiment of the invention, and

FIGS. 4A and 4B are flowcharts illustrating another embodiment of the invention.

### DESCRIPTION OF EMBODIMENTS

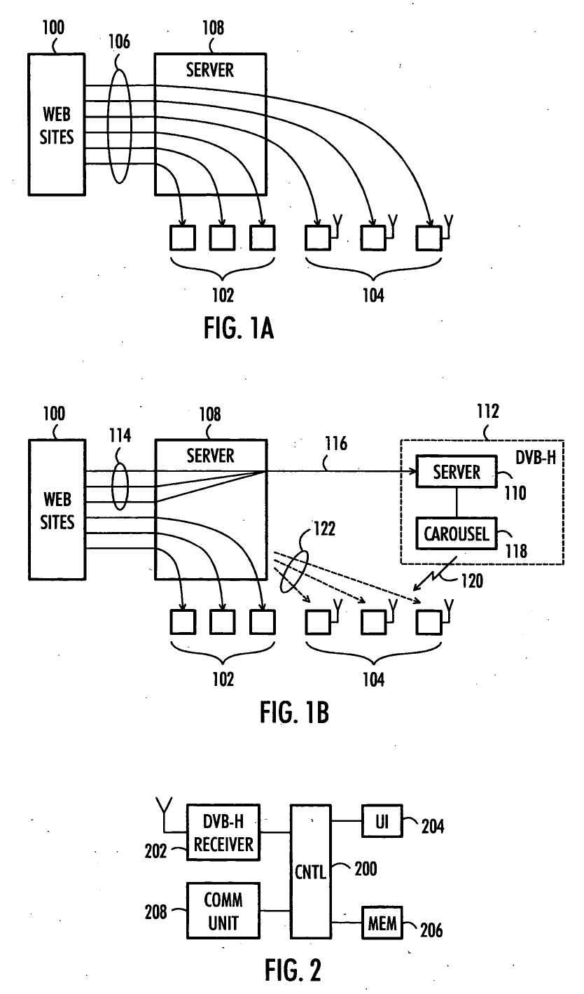

With reference to FIG. 1A, examine an example of a system in which embodiments of the invention can be applied. FIG. 1A shows a set of web sites 100 which offer the content of the web site as a syndicated feed, such as an RSS or ATOM feed. Users of terminals 102, 104 interested in the contents of the web sites may subscribe to the feeds 106 and read the contents using a content reader or a feed reader.

The terminals may be in connection with the web sites in various ways depending on the type of the terminals. The terminals may be computers connected to the Internet via a wireline connection. The terminals may be mobile terminal equipment connected to a mobile network, such as GSM or UMTS. The terminals may be connected to a wireless local area network. In all cases, the connection between the terminal and the web site is a point-to-point connection. The content reader application running in the terminal contacts the web site, and fetches updated content.

Part 104 of the terminals may be equipped with a broadcast receiver. In the following, a DVB-H network and DVB-H transmission are used as examples of a broadcast network and broadcast transmission. One skilled in the art is aware that embodiments of the invention may be applied to other broadcast networks as well. The following description applies to other broadcast solutions with minor changes which are clear to one skilled in the art.

In an embodiment, the system comprises a server or a proxy 108 which monitors the feed traffic of the terminals 104 equipped with a DVB-H receiver. The server 108 monitors the amount of traffic each feed produces and the related costs and the number of subscriptions of each feed, for example. The server may compare the amount of feed traffic of each feed to a given threshold value. The threshold value may be selected on the basis of expected cost of broadcast delivery of feed traffic compared to the cost of using point-to-point connections. Cost can be defined in variety of terms such as monetary, network capacity, and battery power requirement. The threshold value may also be selected on the basis of traffic load of point-to-point connections or of the server 108. If the amount of feed traffic for a feed exceeds the given threshold, then the server 108 may initiate broadcast delivery of the feed.

The broadcast delivery is explained with the help of FIG. 1B. The server 108 aggregates the feeds 114 selected for broadcast delivery and redirects 116 the feeds to a server 110 in a DVB-H network 112.

In an embodiment, the DVB-H network 112 comprises a DVB-H object data carousel 118, and the server 110 in the DVB-H network is configured to load the redirected web feed to the DVB object data carousel for cyclic transmission 120.

The DVB object data carousel 118 is an application that allows a server to distribute a set of separate data objects modules to the DVB-H transmitter by cyclically repeating the contents of the carousel, one or more times. Thus, the same data objects are cyclically repeated in the transmission flow. At the receiver side, if an application decoder wants to access a particular data object from the object data carousel, it may simply wait for the next time that the data for the requested module is broadcast.

The DVB object data carousel is explained in chapter 4.6 of ETSI document “Digital Video Broadcasting (DVB): Implementation guidelines for Data Broadcasting”, ETSI TR 101 202 V1.2.1, which is incorporated herein by reference.

Thus, different aggregated feeds may be stored in the data carousel and transmitted 120 cyclically.

The server 108 informs the content reader of the terminals 104 receiving the feeds that the transmission of the feeds is accessible from the broadcast system.

In an embodiment, there are three different ways of accomplishing the redirection: First, the 108 server redirects the client to a new location with an HTTP redirection. Second, the RSS/ATOM XML content will be updated with a new extension that will request the content reader application to read from the broadcast network. Third, SIP messaging may be used. All these methods need to be augmented with a proper metadata that is able to express that the content is in the broadcast network. The metadata in the HTTP case can be conveyed in a new Content type attribute, for RSS/ATOM one may use same structure as for SIP, i.e. SDP description described in Handley, M. and V. Jacobson, “SDP: Session Description Protocol” RFC 2327, April 1998, which is incorporated herein as a reference. The SDP descriptor may use for example MIME media type name: application and MIME subtype name: DVB-H. This would indicate to the client that DVB-H radio is to be used for the feed.

The use of HTTP and/or RSS/ATOM XML requires changes to RSS client behaviour to process the new extensions so that the client program may switch the reception of the RSS feed (session) to broadcast interface. In the SIP case, the RSS client needs to be SIP aware and work together with SIP user agent in addition of being able to switch the reception of the feed to the DVB-H interface.

The redirection of the feed to the broadcast channel can be implemented by HTTP-protocol as follows. The server sends a REDIRECT message (code 302), that contains the new location information in the location field of the protocol, and properly formatted content type field that indicates together with the location field that the content resides in the DVB-H/broadcast network. In an embodiment, this is done by introducing a new content type such as “datacast” that would define the access to DVB-H carousel” and a related URL.

The use of Session Initiation Protocol and its extension for events and notifications provide a benefit to further optimize the network and server resources as the traffic needs can be followed dynamically. In the following, the use of SIP and a content reader application that is using SIP are used as an example of a redirection method.

SIP (Session Initiation Protocol) messages are commonly used to initiate and terminate sessions and the protocol is widely supported. The server. The server 108 sends a message 122 to the content reader application. The message 122 may include security credentials, and channel and timing information relating to the broadcast system. This may be implemented with a SIP REFER or SIP re-invite message. The message is transmitted using the point-to-point connection used to convey the syndicated feed.

A terminal 104 receiving a SIP REFER message from the server 108 initiates DVB-H reception and starts receiving the feed transmission using DVB-H instead of point-to-point connections.

The content reader application may hide the reception method from the user.

Thus, the most popular feeds are transmitted via a broadcast system to terminals capable of receiving broadcast transmissions. With this solution, valuable transmission capacity is saved and costs minimised in both networks, i.e. broadcast and wide area network.

In an embodiment, when a feed is no longer required in the terminal as a result of an action from the user of the terminal, the feed reader or content reader sends a message to the server 108 that the feed is no longer needed. This may happen if the user unsubscribes to a feed, or if he simply terminates the feed reader application. This may happen also if the user has not used the content reader application or viewed particular feeds in a certain time. This timer-based termination of the redirection is also applicable to HTTP based and RSS/ATOM XML based redirection solutions. As the server 108 monitors the feed traffic, it is advantageous to keep the information up-to-date. As the basic feed operation is fetch-based and not push-based as the broadcasting of feeds, the server 108 has no way of knowing if a terminal does not require a feed any longer which limits the current solutions.

If a required number of cancellations relating to a feed are registered at the server 108, the transmission of the feed may revert back to the traditional method if it turns out to be more economical due to the number of cancellations.

FIG. 2 illustrates an example of a terminal in which embodiments of the invention can be applied. The terminal comprises a controller 200, which can be a processor with associated software, such as a content reader. The terminal further comprises a DVB-H receiver 202 connected to the controller and a user interface 204, which may include a display, a speaker and input devices, such as a keyboard. The terminal may further comprise a memory 206 connected to the controller 200 for storing applications and data. In addition, the terminal comprises a communication unit 208 for forming and maintaining a point-to-point communication link with web sites in the Internet. The communication unit may be a cellular transceiver, a network adapter or a wireless local area network adapter.

The terminal may be a mobile phone, a personal computer, a PDA, or a respective device.

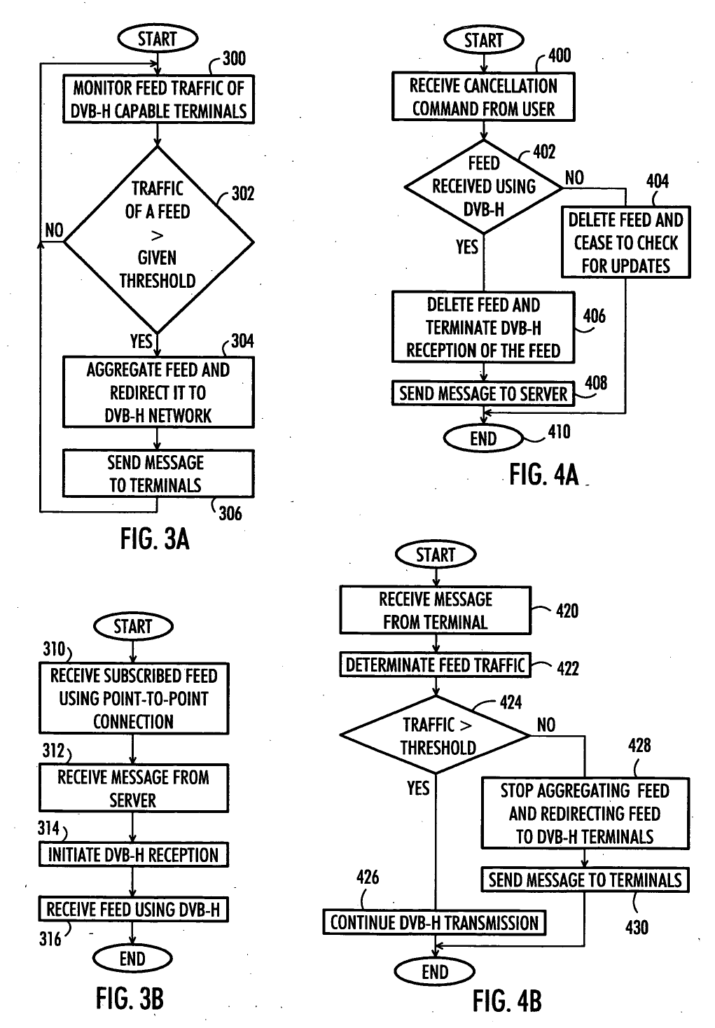

FIG. 3A is a flowchart illustrating an embodiment of the invention from the point of view of the server 108 or proxy. The server 108 or proxy in question may also be a content provider, i.e. it may be a server which produces syndicated feeds.

In step 300, the server 108 monitors syndicated feed traffic of terminals capable of DVB-H reception. The terminal capability information may be obtained from user profile of the user of each terminal, for example. The server 108 may monitor the amount of traffic and the number of subscriptions of each feed. The source and destination addresses of feed traffic and the amount of data in separate sessions may be monitored and statistics relating to each syndicated feed may be gathered. In an embodiment, the cost of delivering the amount of traffic is determined.

In step 302, it is checked whether the traffic of each monitored feed exceeds a given threshold value. If the amount of traffic of a given feed directed to terminals capable of DVB-H reception is sufficiently large, it may be advantageous to transmit the popular feed using a broadcast network. If such a feed is not found, the monitoring continues in step 300.

If such a popular feed was found, the feed is aggregated and redirected to a DVB-H network in step 304. The server communicates with the DVB-H network and receives information about possible security credentials and channel and timing information relating to the transmission of the feed by the DVB-H system. In an embodiment, it is checked whether the cost of delivering the amount of traffic exceeds a given threshold value.

In step 306, the server 108 sends a message to the terminals subscribing the redirected feed. The message comprises information that a feed is now available via the DVB-H network transmission. The message may also comprise information relating to the DVB-H transmission, such as security credentials and channel and timing information of the transmission provided by the DVB-H service system that is connected to DVB-H transmitter. The message is transmitted using the point-to-point connection used to convey the syndicated feed.

The message may be implemented with a SIP REFER or SIP re-invite message. SIP (Session Initiation Protocol) messages are commonly used to initiate, control and terminate sessions. The SIP REFER method is described in Sparks, R., “The Session Initiation Protocol Refer Method”, RFC 3415, April 2003, which is incorporated herein by reference. The RFC documents may be obtained from www.ietf.org web site. REFER is a SIP method which may be used to indicate that the recipient of the message should initiate a connection with a third party using the contact information provided in the message. In this case, the message is used to indicate that the terminal receiving the message should initiate DVB-H reception and start receiving a given syndicated feed using DVB-H.

Thus in an embodiment, the message sent by the server 108 to the terminals comprises following information: identification of a syndicated feed subscribed to by the feed reader of the terminal, notification that the feed is transmitted using DVB-H network and identification of DVB-H parameters enabling the DVB-H reception of the feed.

FIG. 3B is a flowchart illustrating an embodiment of the invention from the point of view of a terminal. In step 310, a terminal with a DVB-H reception capability is subscribing a receiving a syndicated feed using a point-to-point connection. The terminal may be connected to the Internet via a wireline connection, a wireless local area network (WLAN) or a cellular data connection, such as GPRS, for example. A feed reader running in the terminal has subscribed to a set of syndicated feeds. The feed reader may be configured to check for updates of the feeds periodically using the point-to-point connection. Any updated information is shown on the display of the terminal.

In step 312, the terminal receives a message from the server 108. In an embodiment, the message comprises identification of a syndicated feed subscribed to by the feed reader of the terminal and a notification that the feed is transmitted using DVB-H network. The message may further comprise identification of DVB-H parameters enabling the DVB-H reception of the feed.

In step 314, the feed reader of the terminal initiates DVB-H reception based on the parameters in the message.

In step 316, the feed reader of the terminal receives the syndicated feed using DVB-H. In this case, the updated information of the feed is automatically transmitted to the feed reader in the DVB-H transmission. The feed reader does no longer need to perform checks periodically. As the feed reader may subscribe to several feeds, the feed reader may periodically perform checks regarding updates of the other feeds received using point-to-point connections. The user of the terminal may be unaware of the way updates are received by the feed reader. The feed reader may be configured to display the feeds in a similar manner regardless of the way the updates are received.

FIG. 4A is a flowchart illustrating an embodiment of the invention from the point of view of a terminal. In this embodiment, the user of a terminal wishes to stop subscribing to and reading a syndicated feed.

In step 400, the feed reader of a terminal receives a command from the user indicating that the user no longer wishes to subscribe to and receive a given feed.

In step 402, the feed reader checks if the feed is received using DVB-H reception. If this is not the case, the feed is received using conventional point-to-point connections. In step 404, the feed reader deletes feed data from the memory of the terminal and ceases to check for updated information of the feed.

In step 406, if the feed is received using DVB-H, the feed reader deletes feed data from the memory of the terminal and terminates the DVB-H reception of the feed. If there are other feeds that are received via the DVB-H connection, the DVB-H reception continues in respect of these feeds.

In step 408, the terminal sends a message to the server 108. The message indicates that the terminal is no longer subscribing to the given feed. On the basis of the message, the server 108 may keep the feed traffic information up-to-date. The message may be implemented with a SIP SUBSCRIBE method, where subscription life-time is defined as zero. The life-time of a subscription is defined by the “Expires”-header of the SUBSCRIBE method. The SIP SUBSCRIBE method is described in Roach, A. B., “Session Initiation Protocol-Specific Event Notification”, RFC 3265, June 2002, which is incorporated herein by reference.

In step 410, the process ends.

FIG. 4B is a flowchart illustrating an embodiment of the invention from the point of view of the server 108 or proxy. In this embodiment, the user of a terminal wishes to stop subscribing to and reading a syndicated feed.

In step 420, the server 108 receives a message from a terminal that is receiving a feed using DVB-H. The message indicates that the terminal no longer subscribes to a given feed.

In step 422, the server 108 determines the current amount of traffic relating to the given feed. The server 108 may check the number of terminals still receiving the feed using DVB-H and the amount of data transferred, for example.

In step 424, the server 108 checks whether the determined feed traffic exceeds a given threshold value. If the amount of traffic of the given feed directed to terminals capable of DVB-H reception is still sufficiently large, the DVB-H transmission may be continued in step 426.

If the amount of traffic has decreased below the given threshold value, it may be economically feasible to discontinue DVB-H transmission. In such a case, the aggregating of the feed and redirecting the feed to the DVB-H network is terminated in step 428.

In step 430, the server 108 sends a message to the terminals which were receiving the feed using DVB-H. The message indicates to the feed readers running in the terminals that the DVB-H transmission of the feed is discontinued and the feed should be updated using conventional point-to-point connections and no redirection is in effect.

Embodiments of the invention may be realized in an electronic device, comprising a user interface, a point-to-point communication unit, a DVB-H receiver and a controller operationally connected to the user interface, communication unit and the DVB-H receiver. The controller may be configured to perform at least some of the steps described in connection with the flowcharts of FIGS. 3B, 4A and in connection with FIGS. 1A, 1B and 2. The embodiments may be implemented as a computer program comprising instructions for executing a computer process for data reception, the process comprising: receiving a syndicated web feed using a point-to-point connection; receiving a message on a point-to-point connection, the message identifying a syndicated feed received using a point-to-point connection, DVB-H transmission parameters and information that the feed may be decoded from a DVB-H transmission using the DVB-H transmission parameters; initiating DVB-H reception on the basis of the received message, and starting the reception of the feed using the DVB-H transmission parameters. The program may be a feed reader program, for example.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

What is claimed is:

1. A data transmission method, the method comprising
monitoring the amount of traffic originated by the subscriptions of syndicated web feeds by terminals using point-to-point connections, the terminals being capable of broadcast reception;
comparing the cost of delivering the amount of traffic to a predetermined threshold value;
and if the cost of delivering the amount of traffic of a given web feed exceeds the threshold value;
aggregating the web feed and redirecting the feed to a broadcast network;
sending a message to the terminals capable of broadcast reception and subscribing to the feed, the message indicating a command to start receiving the feed from the broadcast network;
transmitting the feed from the broadcast network.

2. The method of claim 1, further comprising: loading the redirected web feed in the broadcast network to a broadcast object data carousel for cyclic transmission.

3. The method of claim 1, wherein the step of sending a message to the terminals comprises sending a SIP refer or a SIP re-invite message to the terminals.

4. The method of claim 1, wherein the step of sending a message to the terminals comprises sending message comprising HTTP-redirection information to the terminals.

5. The method of claim 1, wherein the step of sending a message to the terminals comprises dynamically adding an RSS/ATOM XML based metadata tag to the content of the feed, the tag initiating a redirection request to the terminals.

6. The method of claim 1, further comprising:
receiving a message from a terminal indicating that the terminal has stopped receiving a given feed transmitted from a broadcast network,
determining the amount of traffic of the given feed redirected to the broadcast network,
comparing the amount of traffic to a predetermined threshold value;
and if the amount of traffic of a given web feed falls below the threshold value, ceasing the aggregation and redirection of the feed to the broadcast network.

7. The method of claim 1, further comprising: setting the threshold value on the basis of transmission costs of point-to-point connection versus transmission costs of broadcast transmission.

8. The method of claim 1, further comprising: setting the threshold value on the basis of traffic load of point-to-point connections.

9. The method of claim 1, wherein the broadcast network is a DVB-H network.

10. A data transmission method, the method comprising
monitoring the amount of traffic originated by the subscriptions of syndicated web feeds by terminals using point-to-point connections, the terminals being capable of broadcast reception;
comparing the amount of traffic to a predetermined threshold value;
and if the amount of traffic of a given web feed exceeds the threshold value;
aggregating the web feed and redirecting the feed to a broadcast network;
sending a message to the terminals capable of broadcast reception and subscribing to the feed, the message indicating a command to start receiving the feed from the broadcast network;
transmitting the feed from the broadcast network.

11. An arrangement for data transmission, comprising a server configured to
monitor the amount of traffic originated by the subscriptions of syndicated web feeds by terminals using point-to-point connections, the terminals being capable of broadcast reception;
compare the cost of delivering the amount of traffic to a predetermined threshold value; and
if the cost of delivering the amount of traffic of a given web feed exceeds the threshold value, the server is configured to
aggregate the web feed and redirect the feed to a broadcast network;
send a message to the terminals capable of broadcast reception and subscribing to the feed, the message indicating a command to start receiving the feed from the broadcast network.

12. The arrangement of claim 11, wherein the server is configured to send a SIP refer or SIP re-invite message to the terminal equipment.

13. The arrangement of claim 11, further comprising a second server in the broadcast network configured to receive redirected feed from the server and transmit the feed from the broadcast network.

14. The arrangement of claim 11, further comprising a broadcast object data carousel in the broadcast network, and wherein the second server in the broadcast network is configured to load the redirected web feed to the broadcast object data carousel for cyclic transmission.

15. The arrangement of claim 11, wherein the broadcast network is a DVB-H network.

16. The arrangement of claim 11, wherein the server is configured to send a message comprising HTTP-redirection information to the terminal equipment.

17. The arrangement of claim 11, wherein the server is configured to dynamically add an RSS/ATOM XML based metadata tag to the content of the feed, the tag initiating a redirection request to the terminals.

18. An arrangement for data transmission, comprising a server configured to
monitor the amount of traffic originated by the subscriptions of syndicated web feeds by terminals using point-to-point connections, the terminals being capable of broadcast reception;
compare the amount of traffic to a predetermined threshold value; and
if the amount of traffic of a given web feed exceeds the threshold value, the server is configured to
aggregate the web feed and redirect the feed to a broadcast network;
send a message to the terminals capable of broadcast reception and subscribing to the feed, the message indicating a command to start receiving the feed from the broadcast network.

19. An arrangement for data transmission, comprising
means for monitoring the amount of traffic originated by the subscriptions of syndicated web feeds by terminals using point-to-point connections, the terminals being capable of broadcast reception;
means for comparing the cost of delivering the amount of traffic to a predetermined threshold value; and
if the cost of delivering the amount of traffic of a given web feed exceeds the threshold value
means for aggregating the web feed and redirecting the feed to a broadcast network; and
means for sending a message to the terminals capable of broadcast reception and subscribing to the feed, the message indicating a command to start receiving the feed from the broadcast network.

20. A terminal comprising
first transceiver means for having a point-to-point connection with the Internet and for receiving syndicated web feeds using a point-to-point connection;
receiving means for receiving broadcast transmissions,
second transceiver means for receiving a message on a point-to-point connection, the message identifying a syndicated feed received using a point-to-point connection, broadcast transmission parameters and information that the feed may be decoded from a broadcast transmission using the broadcast transmission parameters, and
controlling means for initiating broadcast reception on the basis of the received message.

21. The terminal of claim 20, further comprising a user interface for receiving a command to discontinue receiving a syndicated feed, and
controlling means for stopping the decoding of the feed from broadcast transmission, and for sending a message using the first transceiver, the message identifying the feed and comprising information that the feed is no longer received by the terminal.

22. A terminal comprising
a first transceiver having a point-to-point connection with the Internet and receiving syndicated web feeds using a point-to-point connection;
a receiver receiving broadcast transmissions,
a second transceiver receiving a message on a point-to-point connection, the message identifying a syndicated feed received using a point-to-point connection, broadcast transmission parameters and information that the feed may be decoded from a broadcast transmission using the broadcast transmission parameters, and
a controller initiating broadcast reception on the basis of the received message.

23. A data reception method in a terminal, the method comprising:
receiving a syndicated web feed using a point-to-point connection;
receiving a message on a point-to-point connection, the message identifying a syndicated feed received using a point-to-point connection, broadcast transmission parameters and information that the feed may be decoded from a broadcast transmission using the broadcast transmission parameters;
initiating broadcast reception on the basis of the received message, and
starting the reception of the feed using the broadcast transmission parameters.

24. The method of claim 23, further comprising
receiving a command to discontinue receiving a syndicated feed,
stopping the decoding of the feed from broadcast transmission, and
sending a message on a point-to-point connection, the message identifying the feed and comprising information that the feed is no longer received by the terminal.

25. A computer program distribution medium readable by a computer and encoding a computer program of instructions for executing a computer process for data transmission, the process comprising:
monitoring the amount of traffic originated by the subscriptions of syndicated web feeds by terminals using point-to-point connections, the terminals being capable of broadcast reception;
comparing the cost of delivering the amount of traffic to a predetermined threshold value; and if the cost of delivering the amount of traffic of a given web feed exceeds the threshold value,
aggregating the web feed and redirecting the feed to a broadcast network; and
sending a message to the terminals capable of broadcast reception and subscribing to the feed, the message indicating a command to start receiving the feed from the broadcast network.

26. A computer program distribution medium readable by a computer and encoding a computer program of instructions for executing a computer process for data reception, the process comprising:
receiving a syndicated web feed using a point-to-point connection;
receiving a message on a point-to-point connection, the message identifying a syndicated feed received using a point-to-point connection, broadcast transmission parameters and information that the feed may be decoded from a broadcast transmission using the broadcast transmission parameters;
initiating broadcast reception on the basis of the received message, and
starting the reception of the feed using the broadcast transmission parameters.

27. The computer program distribution medium of claim 25, the distribution medium including at least one of the following media: a computer readable medium, a program storage medium, a record medium, a computer readable memory, a computer readable software distribution package, a computer readable signal, a computer readable telecommunications signal, and a computer readable compressed software package.
